(19) United States
(12) Patent Application Publication
(10) Pub. No.: US 2006/0146776 A1
(43) Pub. Date: Jul. 6, 2006

(54) Network-based robot control system

(75) Inventor: Kyoung Jin Kim, Seoul (KR)

Correspondence Address: BIRCH STEWART KOLASCH & BIRCH, PO BOX 747, FALLS CHURCH, VA, 22040-0747, US

(73) Assignee: iO.TEK Co., Ltd.

(21) Appl. No.: 11/319,433

(22) Filed: Dec. 29, 2005

(30) Foreign Application Priority Data
Dec. 30, 2004 (KR) 10-2004-116215

(51) Int. Cl. H04Q 7/24

(52) U.S. Cl. 370/338; 370/392

(57) ABSTRACT

Disclosed herein is a network-based robot control system. The network-based robot control system includes robot terminals, communication modules, and a service server. The service server receives sensing values from sensors of each of the robot terminals through each of the communication modules, generates downstream packets so that synchronous motion control data, voice data or image data is included in a single packet, and transmits the downstream packets to the robot terminal through the communication module. The robot terminal receives the transmitted downstream packets, sequentially stores the downstream packets in a downstream buffer, reads the downstream packets stored in the downstream buffer, and performs a motion or plays voice or images according to the read downstream packets.

### BACKGROUND OF THE INVENTION

1. Field of the Invention

The present invention relates to a network-based robot control system.

2. Description of the Related Art

In the future, home robots will spread to almost every household, and will be utilized in various ways, such as performing necessary operations in response to various signals, such as sensing signals from various types of sensors (an image sensor, a distance sensor, a contact sensor and the like) installed in the home robot, or control command signals provided from the outside.

Meanwhile, current home robots must internally process and analyze sensing signals from various types of sensors and control command signals from the outside, create data for the control of joints and the like to perform necessary operations based on processing and analysis results, and perform Text-To-Speech (TTS) processing to convert text data, which is received from the outside, into voice so as to implement speech based on the text data, so that current home robots require high-capacity Central Processing Units (CPUs) and high-capacity memory.

In particular, since an Operating System (OS), such as Microsoft Windows, is required to utilize the general applications of a Personal Computer (PC) (for example, an electronic mail application) in robots, the CPUs and the memory must have capacities that meet the requirements of the OS so as to boot the OS.

In summary, in a current home robot system, a high-capacity CPU and high-capacity memory are required to process and analyze various types of sensor signals, create necessary control data, and perform TTS conversion. As a result, the price of the home robot system is high, therefore it is difficult for consumers to purchase such home robot systems.

### SUMMARY OF THE INVENTION

Accordingly, the present invention has been made keeping in mind the above problems occurring in the prior art, and an object of the present invention is to provide a network-based robot control system, in which each robot terminal (a robot that is equipped only with basic components and allows a service server to perform most of the processing, like a computer terminal) is provided only with basic components, and in which a service server connected to a network processes tasks requiring a high-capacity CPU and high-capacity memory, such as the analysis and processing of various motion/voice/image data, and transmits processing results to the robot terminal, thereby providing remotely controllable, inexpensive robot terminals.

In order to accomplish the above object, the present invention provides a network-based robot control system, including robot terminals, communication modules, and a service server; wherein the service server receives sensing values from sensors of each of the robot terminals through each of the communication modules, generates downstream packets so that synchronous motion control data, voice data or image data is included in a single packet, and transmits the downstream packets to the robot terminal through the communication module; and wherein the robot terminal receives the transmitted downstream packets, sequentially stores the downstream packets in a downstream buffer, reads the downstream packets stored in the downstream buffer, and performs a motion or plays voice or images according to the read downstream packets.

In addition, the present invention provides a processing method for a network-based robot control system, the network-based robot control system having robot terminals, communication modules, and a service server, including the steps of the service server receiving sensing values from sensors of each of the robot terminals through each of the communication modules, generating downstream packets so that synchronous motion control data, voice data or image data is included in a single packet, and transmitting the downstream packets to the robot terminal through the communication module; and wherein the robot terminal receives the transmitted downstream packets, sequentially stores the downstream packets in a downstream buffer, reads the downstream packets stored in the downstream buffer, and performs a motion or plays voice or images according to the read downstream packets.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the entire construction of the present invention;

FIG. 2 is a flowchart illustrating a process in which the robot terminal of the present invention connects to a service server when power is applied to the robot terminal;

FIG. 3 is diagram illustrating a combined communication method according to the present invention; and

FIG. 4 is a diagram illustrating the format of packet data used in the present invention of FIG. 3.

### DESCRIPTION OF THE PREFERRED EMBODIMENTS

Reference now should be made to the drawings, in which the same reference numerals are used throughout the different drawings to designate the same or similar components.

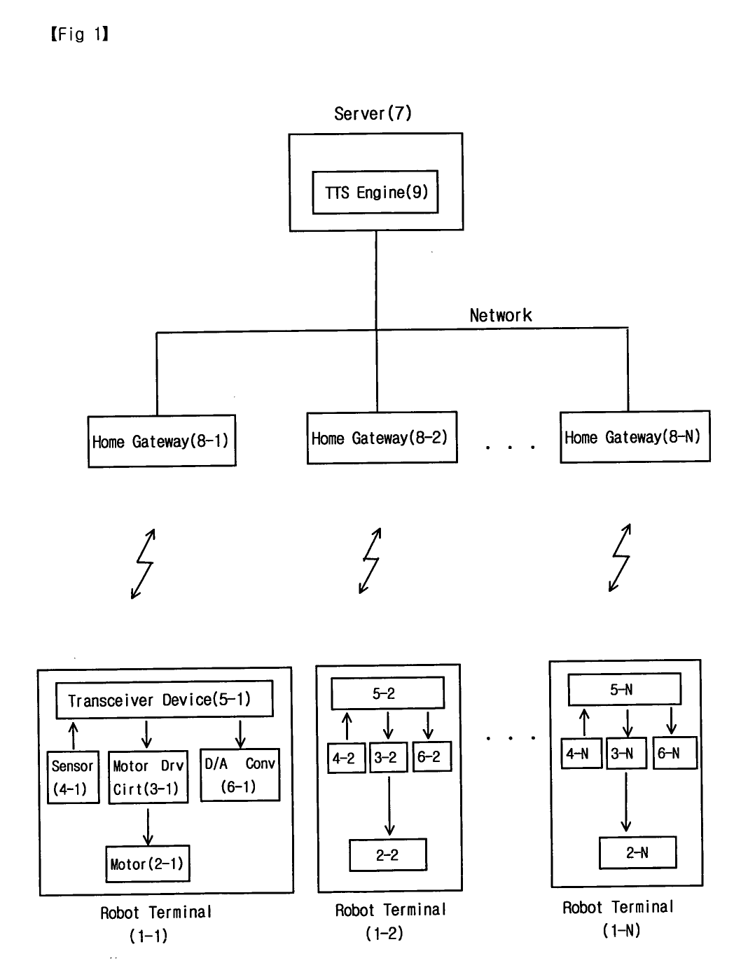

The construction and operation of the present invention are described below with reference to FIG. 1.

Each robot terminal 1-1, 1-2, . . . , or 1-N of a home includes a motor 2-1, 2-2, . . . , or 2-N for actuating joints and wheels, a motor drive circuit 3-1, 3-2, . . . , or 3-N for driving the motor 2-1, 2-2, . . . , or 2-N, sensors 4-1, 4-2, . . . , or 4-N, a transceiver device 5-1, 5-2, . . . , or 5-N for transmitting sensing signals, which are transmitted from the sensors 4-1, 4-2, . . . , or 4-N, to a server 7 and receiving data, which is transmitted from the server 7, at the robot terminal 1-1, 1-2, . . . , or 1-N, a Digital/Analog (D/A) converter 6-1, 6-2, . . . , or 6-N for issuing utterances for a voice file, which is transferred from the server 7, if necessary, and an image display control device (not shown) for displaying a transferred image file on a monitor when the robot terminal 1-1, 1-2, . . . , or 1-N has a monitor installed therein.

The transceiver device 5-1, 5-2, . . . , or 5-N of each robot terminal 1-1, 1-2, . . . , or 1-N is wirelessly connected to each home gateway 8-1, 8-2, . . . , or 8-N that is assigned an unique Internet Protocol (IP) address, and each home gateway 8-1, 8-2, . . . , or 8-N is connected to the server 7.

The server 7 receives sensing signals from the various sensors 4-1, 4-2, . . . , or 4-N of each robot terminal 1-1, 1-2, . . . , or 1-N through each home gateway 8-1, 8-2, . . . , or 8-N, performs necessary processing and analysis, transmits motion control data to the robot terminal 1-1, 1-2, . . . , or 1-N, and transmits a voice file and an image file if necessary.

The robot terminal 1-1, 1-2, . . . , or 1-N, having received the motion control data through the transceiver device 5-1, 5-2, . . . , or 5-N, transmits the motion control data to the motor drive circuit 3-1, 3-2, . . . , or 3-N for joints and wheels, so that the motor drive circuit 3-1, 3-2, . . . , or 3-N drives the motor 2-1, 2-2, . . . , or 2-N. As a result, the robot terminal 1-1, 1-2, . . . , or 1-N performs an appropriate operation.

Furthermore, in the case of issuing utterances related to an operation while performing the motion, or in the case of issuing utterances related to the reading of e-mail, when the server 7 generates a voice file related to the motion or generates a voice file by converting e-mail into the voice file using its TTS engine 9, and transmits the generated voice file to the robot terminal 1-1, 1-2, . . . , or 1-N, the robot terminal 1-1, 1-2, . . . , or 1-N, having received the voice file, converts the voice file into analog voice signals using the D/A converter 6-1, 6-2, . . . , or 6-N and issues utterances through a speaker.

Furthermore, if there are images related to the motion or utterances, a received image file is transmitted to the image display control device, so that the related images are displayed on the monitor of the robot terminal 1-1, 1-2, . . . , or 1-N.

As described above, when the robot terminal 1-1, 1-2, . . . , or 1-N is provided only with the transceiver device 5-1, 5-2, . . . , or 5-N for the transmission and reception of data to and from the server 7, the sensors 4-1, 4-2, . . . , or 4-N, the motor 2-1, 2-2, . . . , or 2-N, the motor drive circuit 3-1, 3-2, . . . , or 3-N and, if necessary, the D/A converter 6-1, 6-2, . . . , or 6-N and/or the image display control device, and high-capacity data processing, such as the generation of motion control data for the robot terminal 1-1, 1-2, . . . , or 1-N and the generation of voice files and/or image files, is allowed to be performed in the service server 7, the robot terminal 1-1, 1-2, . . . , or 1-N does not require a high-capacity CPU and high-capacity memory, so that it is possible to provide inexpensive home robots at a low price.

Now, the home gateway 8 used for the present invention is described in more detail below.

The home gateway 8 is connected using various methods. For example, wired methods, such as an Ethernet LAN method, a Power Line Communication (PLC) method and a home Phoneline Networking Alliance (PNA) method, may be used.

The robot terminal 1 of the present invention can basically communicate with the home gateway 8, as illustrated in FIG. 1. In a home having no home gateway 8 because a home network is not installed, wireless communication with the robot terminal 1 is performed using an Access Point (AP) connected to a high-speed Internet line and a wireless LAN (not shown), instead of the home gateway 8. In this case, the robot terminal 1 must includes an Internet protocol directly connectable to the service server 7 and wireless LAN (IEEE 802.11x). In addition to wireless LAN (IEEE 802.11x), wireless communication technology developed for home networking includes HomeRF, Bluetooth, Ultra Wide Bandwidth (UWB), wireless 1394, ZigBee, Wireless USB, etc.

Next, a method in which the robot terminal 1 of the present invention connects to the service server 7 is described below.

Since the functions of the robot terminal 1 itself according to the present invention are very limited, the assistance of the service server 7 is absolutely necessary. Accordingly, when power is applied to the robot terminal 1, the robot terminal 1 must connect to the network and communicate with the service server 7.

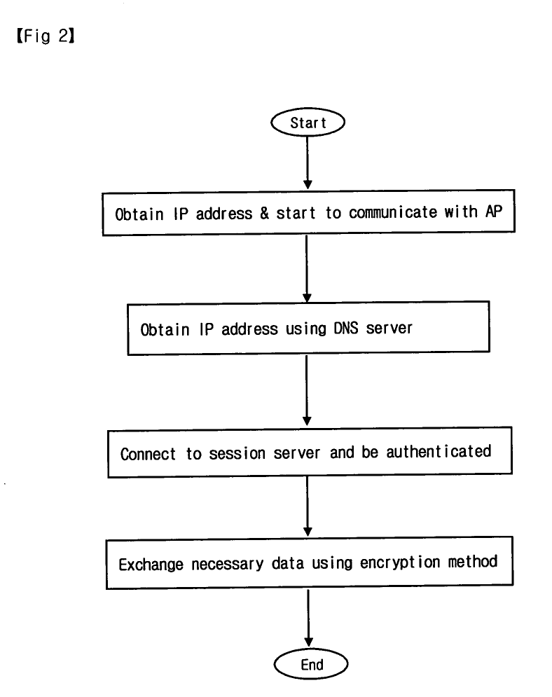

A process in which the robot terminal 1 connects to the service server 7 when power is applied to the robot terminal is described with reference to FIG. 2. The case where the robot terminal 1 connects to the service server 7 through a home AP and the Internet is described.

1. The robot terminal 1 obtains a local IP address using Dynamic Host Configuration Protocol (DHCP), and starts to communicate with the AP.

2. The robot terminal 1 finds the IP address of the domain of the service server 7 using Domain Name Service (DNS).

3. The robot terminal 1 connects to a session server and is authenticated.

4. The robot terminal 1 transmits and receives necessary data using an encryption method.

Thereafter, a method of transmitting and receiving data between the service server 7 and the robot terminal 1 in the transceiver device 5 is described below.

Unlike a typical robot, for the service server 7 to remotely control the robot terminal 1 connected to the network, the following two aspects must be taken into account.

First, the lack of uniformity of time delay and arrival time that occur at the time of transmitting data via a network must be taken into account. Second, a process of reacting and causing a necessary motion in real time to be performed when the robot terminal 1 moves or interacts with a human must be taken into account.

For example, if voice information, which is converted into a voice file by the TTS engine 9 of the service server 7, and motion information, which is a motion control data file (for example, motion control data for the movement of lips), are separately transmitted so as to cause the robot terminal 1 to perform a corresponding operation while issuing utterances, the arrival time of the voice information and the arrival time of the motion information do not coincide with each other, so that it is impossible for the robot terminal 1 to perform the corresponding motion while issuing utterances.

In order to prevent the above problem, a method of installing a large amount of buffer memory in the robot terminal 1, receiving and storing voice information and motion information, and performing a corresponding motion while issuing utterances may be considered. However, this method employs a technique of playing voice information and motion information after receiving overall voice information and motion information, so that it is defective in that it does not react in real time.

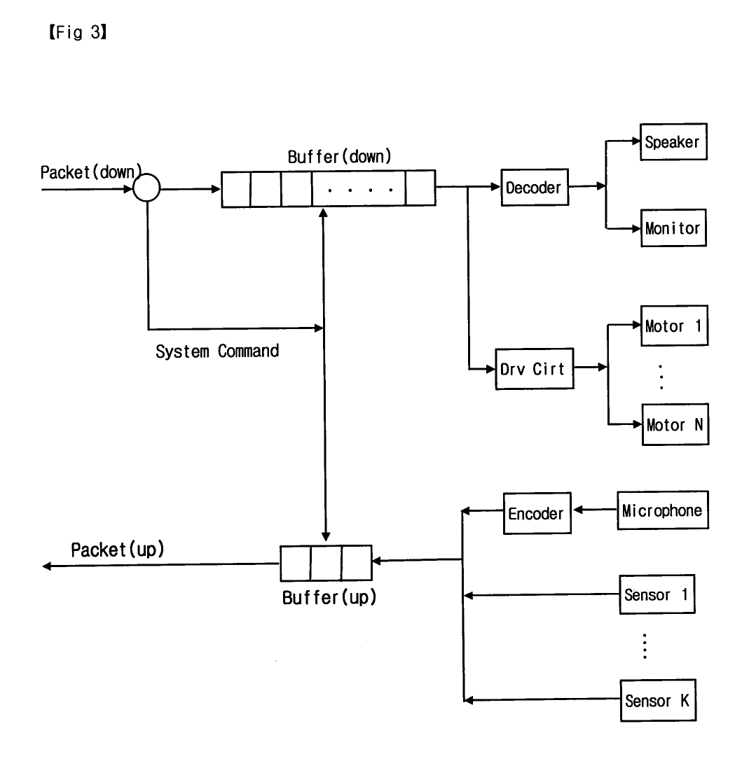

Accordingly, in the present invention, data between the robot terminal 1 and the service server 7 is classified into synchronous data and asynchronous data. A combined transmission method is employed to correspond to the characteristics of respective types of data, as illustrated in FIG. 3.

In that case, synchronous data is data that is used to cause the robot terminal 1 to continuously perform motions, issue utterances and perform an image display, and refers to motion data (for example, data related to the movement of the lips, the expression of the face and the action of the body), and voice and/or image data corresponding to the motion data. These voice and image data are collectively referred to as multimedia data. Furthermore, synchronous data refers to data that is not generated by interaction with surroundings or a human but is previously prepared and stored in the service server 7. Asynchronous data refers to the outputs of the sensors 4, which are transmitted in real time, and system commands, which are real-time control data urgently transmitted from the service server 7, other than previously stored multimedia data.

System commands must be executed as soon as they are received. System commands may be classified as follows:

1. Commands related to a network: data related to a MAC address, a wireless operation mode and an AP

2. Data related to authentication and security

3. Commands related to the playing of multimedia: data related to a playing rate, a screen size, Mono/Stereo switching, etc.

4. Buffer control commands: data related to the clearing of a buffer, the filling of a buffer, the currently remaining size of a buffer, the adjustment of the size of a buffer, etc.

5. Data related to the setting of a sensor table: data related to the setting of the types of sensors and the intervals of transmission

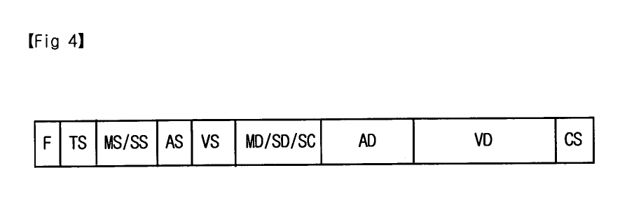

FIG. 4 illustrates the format of a data packet that is used for the communication method of FIG. 3. A header field includes a flag F distinguishing synchronous data from asynchronous data, a time stamp TS indicating the time when a packet was generated, the size MS of the motion data of the following downstream packet for synchronous data or the size SS of a sensor value for the following upstream packet, the size AS of voice data, and the size VS of image data. A motion data field MD, a sensor data field SD and a system command field SC include a motion data file for the motor for performing the motion of the robot terminal 1, a sensor value detected by the sensor, and the content of a system command, respectively. A voice data field AD includes a voice file used for the issuance of utterances in the case of issuing utterances while performing a motion or without performing a motion, or a voice file used for voice input through the microphone of the robot terminal 1. An image data field VD includes an image data file that must be displayed on a monitor in conjunction with motions and/or utterances, or an image data file that is detected by the camera of the robot terminal 1. Finally, a Check-Sum (CS) that indicates the validity of the operation data MD, the sensor data SD, the system command SC, the voice data AD and the image data VD is included.

Referring to FIG. 3 again, data transmitted from the service server 7 is transferred to the robot terminal 1 in the form of downstream packets using TCP/IP or UDP/IP protocol, and the robot terminal 1 reads a flag F from the header field of the transmitted downstream packet and sequentially stores the packet in a downstream buffer (the size of the buffer is determined so that playing is completed within a given time Ts) if the data included in the packet is synchronous data, or directly transfers the packet without storage in the buffer if the data is a system command, that is, asynchronous data, so that the robot terminal 1 immediately executes an operation corresponding to the system command field.

Synchronous data stored in the form of packets in the downstream buffer is read from the downstream buffer by the processing device (not shown) of the robot terminal 1 one by one, and the data size fields MS, AS and VS included in the header field are examined. If all of motion, voice and image data is included in the synchronous data, data corresponding to the motion data field MD, the voice data region AD and the image data field VD is read, the motion data MD is transferred to the motor drive circuit 3, thereby operating the motor 2 and performing a motion, voice data AD is converted into an analog voice signal through a decoder and the D/A converter 6, thereby issuing utterances through the speaker, and the image data VD is displayed on the monitor through the decoder and the image display control device.

Now, a detailed description is given, with the case where the robot terminal 1 is operated at an interval of Ts=40 ms (25 per second), the voice data AD is 16 bit and 16,000 Hz (32,000 bytes per second) Adaptive Differential Pulse Coded Modulation (ADPCM) data, the image data VD does not exist, and 50 buffers are used, being taken as an example.

The downstream buffer of the robot terminal 1 can store 40 ms×50=2.0 seconds of synchronous data, so that an unexpected communication failure for up to two seconds can be overcome and a motion and an utterance without disconnection is guaranteed. In this case, when an ADPCM algorithm having a compression rate of ¼ is employed, the size of necessary memory for voice data is 320 bytes×50=16 Kbytes because voice data of 32,000 bytes/4/25=8,000/25=320 bytes is stored in a single buffer. The size of voice data AD will increase or decrease depending on the status of communication, the quality of voice data or the like.

Next, an operation based on the system command SC is described using an example.

When the robot terminal 1 plays stereo music while mono voices are issued, the following two methods may be used.

1. The service server 7 transmits a system command SC directing the transmission of the remaining size of a buffer to the robot terminal 1 and receives the remaining size of the buffer. When the received value is 0, the service server 7 transmits a system command SC directing the change of the playing function to a stereo mode to the robot terminal 1 and starts to transmit synchronous data, including new stereo audio data, after the robot terminal 1 has changed the audio play mode to the stereo mode.

2. When the service server 7 transmits a system command SC directing the clearing of the content of the buffer to the robot terminal 1 and the robot terminal 1 clears the content of the buffer, the service server 7 transmits a system command SC directing the change of an audio play mode to a stereo play mode to the robot terminal 1 and the robot terminal 1 changes the audio play mode to the stereo play mode, the service server 7 starts to transmit synchronous data including new stereo audio data.

Next, an upstream packet transmitted from the robot terminal 1-1, 1-2, . . . , or 1-N to the service server 7 is described. Analog voice data input from a microphone is converted into digital data by an A/D converter (not shown), is compressed by an encoder, is stored in an upstream buffer (which has a considerably small size compared to the downstream buffer), along with the outputs of various sensor S1, . . . , and Sk, and is transmitted to the service server 7 in the form of packets.

Now, the sensor value of an upstream packet transmitted from the robot terminal 1 to the service server 7 is described in detail.

In a general robot remote control system controlled by a network, a command is transmitted downward, and then the value of a sensor reacting to the command is detected. However, in the method, the received value of the sensor is different from the current value of the sensor due to network time delay. For example, when a robot encounters an unexpected obstacle while moving, an urgent measure may be realized only after collision with the obstacle, even though the robot takes the urgent measure (for example, a service server issues a command that the robot urgently stops).

In the present invention, a specific sensor value is periodically transmitted regardless of the request of the service server 7 so as to overcome the problem of the prior art. In other words, specific sensor values determined to be necessary, for example, distance/ultrasonic/body detection sensor values during movement, are transmitted at preset intervals without any direction of the service server 7. The method has the disadvantage of continuously occupying the communication bandwidth, but can deal rapidly with unexpected hindrances. Meanwhile, using a UDP communication method instead of a TCP communication method, transmission is performed regardless of where reception is performed, so that there is a possibility that some packets may be lost. However, the method has a short transmission interval, so that great problems rarely occur even if there is such a slight loss. As a result, since sensor values are transmitted at considerably short and preset intervals, it is very easy to predict sensor values at the next interval and extrapolate lost values. In practice, the transmission interval of the sensor preferably falls within a range from 20 ms to 100 ms, and this transmission interval will vary depending on the status of communication and the operating rate and accuracy of the robot terminal 1.

As a result, since it is very ineffective to transmit the values of variation from all of the various sensors installed in the robot terminal 1 at such short intervals, the values of environmental sensors, such as temperature and humidity sensors, are transmitted at long intervals because variation in the values of them is low. In contrast, the values of a distance sensor and a sound-related sensor are transmitted at considerably short intervals in consideration of the characteristics thereof.

In the present invention, the service server 7 sets the types of necessary sensor values and the intervals at which sensor values are transmitted in the robot terminal 1 using a system command SC, and information about the types of sensor values and the intervals of transmission of the sensor values, which are required by the service server 7, is stored in the robot terminal 1 in the form of a sensor table.

Through the sensor table, the robot terminal 1 becomes aware of the types of sensors, which must transmit sensor values to the service server 7, and the corresponding intervals of transmission, reads sensor values from corresponding sensors at corresponding intervals, and transmits the sensor values to the service server 7. The set sensor table is continuously effective until the next setting is performed.

Although the preferred embodiment of the present invention has been described, it must be noted that the present invention is not limited to this embodiment, but various medications are possible in a range without departing from the spirit of the present invention.

For example, although the interval of the formation and play of downstream packet data has been described as being 40 ms, the interval can vary in consideration of the status of a communication line or the accuracy of the robot terminal 1.

Furthermore, although the home gateway 8 or the access point has been described as being installed in a home and the robot terminal 1 has been described as communicating with the service server 7 through the home gateway 8 or the access point, the communication with the service server 7 can be performed outdoors when access to a broadband wireless network, such as a Worldwide interoperability for Microwave Access (WiMax) network, is acquired.

Although the service server 7 has been described as being installed outside a home, a home PC may take over the role of the service server 7.

Meanwhile, although the robot terminal 1 has been illustrated as being an actual robot having a machine-like appearance, the robot terminal 1 may be a virtual robot that is simulated on the screen of one of the various terminals (a PC, a mobile phone, and a personal digital assistant) graphically.

Utilizing the present invention described above, it is made possible to provide remotely controllable, inexpensive robot terminals by providing the robot terminals only with basic components, while processing tasks requiring a high-capacity CPU or high-capacity memory, such as the analysis or processing of various motion/voice/image data, in the service server connected to the network, and transmitting analysis and processing results back to the robot terminals.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A network-based robot control system, comprising:
robot terminals, communication modules, and a service server;
wherein the service server receives sensing values from sensors of each of the robot terminals through each of the communication modules, generates downstream packets so that synchronous motion control data, voice data or image data is included in a single packet, and transmits the downstream packets to the robot terminal through the communication module; and
wherein the robot terminal receives the transmitted downstream packets, sequentially stores the downstream packets in a downstream buffer, reads the downstream packets stored in the downstream buffer, and performs a motion or plays voice or images according to the read downstream packets.

2. The network-based robot control system as set forth in claim 1, wherein the communication module is a home gateway.

3. The network-based robot control system as set forth in claim 1, wherein the communication module is an access point connected to an Internet and a wireless Local Area Network (LAN) device.

4. The network-based robot control system as set forth in claim 1, wherein the robot terminal is an actual robot.

5. The network-based robot control system as set forth in claim 1, wherein the robot terminal is a virtual robot that is simulated on a screen graphically.

6. The network-based robot control system as set forth in claim 1, wherein each of the downstream packets further includes asynchronous data corresponding to a system command, that is, real-time control data, and the system command is not stored in the downstream buffer but is directly transferred and executed.

7. The network-based robot control system as set forth in claim 6, wherein each of the downstream packets includes a flag that indicates whether the data included in the downstream packet is synchronous data or asynchronous data.

8. The network-based robot control system as set forth in claim 1, wherein the robot terminal further includes an upstream buffer for receiving and storing sensing values of the sensors, and the sensing values are read from the upstream buffer and transmitted to the service server through the communication module in packet form.

9. The network-based robot control system as set forth in claim 8, wherein the sensing values are received from the sensors at intervals that are determined in consideration of rates of variation in the sensing values.

10. A processing method for a network-based robot control system, the network-based robot control system having robot terminals, communication modules, and a service server, comprising the steps of:
the service server receiving sensing values from sensors of each of the robot terminals through each of the communication modules, generating downstream packets so that synchronous motion control data, voice data or image data is included in a single packet, and transmitting the downstream packets to the robot terminal through the communication module; and
wherein the robot terminal receives the transmitted downstream packets, sequentially stores the downstream packets in a downstream buffer, reads the downstream packets stored in the downstream buffer, and performs a motion or plays voice or images according to the read downstream packets.

11. The processing method for a network-based robot control system as set forth in claim 10, wherein the robot terminal is an actual robot.

12. The processing method for a network-based robot control system as set forth in claim 10, wherein the robot terminal is a virtual robot that is simulated on a screen graphically.

13. The processing method for a The network-based robot control system as set forth in claim 10, wherein each of the downstream packets further includes asynchronous data corresponding to a system command, that is, real-time control data, and the system command is not stored in the downstream buffer but is directly transferred and executed.
